(19) United States
(12) Patent Application Publication
(10) Pub. No.: US 2015/0084864 A1
(43) Pub. Date: Mar. 26, 2015

(54) Input Method

(71) Applicants: Ryan Geiss, San Jose, CA (US); Hayes Solos Raffle, Palo Alto, CA (US); Adrian Wong, Mountain View, CA (US)

(72) Inventors: Ryan Geiss, San Jose, CA (US); Hayes Solos Raffle, Palo Alto, CA (US); Adrian Wong, Mountain View, CA (US)

(73) Assignee: GOOGLE INC., Mountain View, CA (US)

(21) Appl. No.: 13/345,814

(22) Filed: Jan. 9, 2012

(51) Int. Cl. G06F 3/033

(52) U.S. Cl. 345/158

(57) ABSTRACT

Methods and systems for authenticating a user using eye tracking information are described. A wearable computing system may include a head mounted display (HMD). The wearable computing system may be operable to be in a locked mode of operation after a period of inactivity by a user. Locked mode of operation may include a locked screen and reduced functionality of the wearable computing system. The user may be authenticated to be able to use the wearable computing system after the period of inactivity. The wearable computing system may generate a display of a random content on the HMD including a content personalized to the user. The wearable computing system may receive information associated with a gaze location of an eye of the user and determine that the gaze location substantially matches a predetermined location of the content personalized to the user on the HMD and authenticate the user.

### BACKGROUND

Wearable computers include electronic devices that may be worn by a user. As examples, wearable computers can be under or on top of clothing or integrated into eye glasses. There may be constant interaction between a wearable computer and a user. The wearable computer may be integrated into user activities and may be considered an extension of the mind and/or body of the user.

The wearable computer may include an image display element close enough to an eye of a wearer such that a displayed image fills or nearly fills a field of view associated with the eye, and appears as a normal sized image, such as might be displayed on a traditional image display device. The relevant technology may be referred to as “near-eye displays.” Near-eye displays may be integrated into wearable displays, also sometimes called “head-mounted displays” (HMDs).

### SUMMARY

The present application discloses systems and methods to unlock a screen using eye tracking information. In one aspect, a method is described. The method may comprise generating a display of a random content on a head-mounted display (HMD) of a wearable computing system. The random content may at least include among other content a content personalized to a user of the wearable computing system including one or more of a name and a picture associated with the user. The wearable computing system may be operable to be in a locked mode of operation and may include an eye tracking system. The method may also comprise receiving information associated with a gaze location of an eye of the user from the eye tracking system. The method may further comprise determining that the gaze location substantially matches a predetermined location of the content personalized to the user on the HMD. The method may also comprise determining that a responsiveness metric is less than a predetermined threshold. The responsiveness metric may include a time period elapsed between generating the display of the random content on the HMD and determining that the gaze location substantially matches the predetermined location of the content personalized to the user on the HMD. The method may further comprise authenticating the user. Authenticating the user may comprise a switch from the wearable computing system being in the locked mode of operation to being in an unlocked mode of operation. Functionality of the wearable computing system may be reduced in the locked mode as compared to the unlocked mode.

In another aspect, a computer readable memory having stored therein instructions executable by a computing device to cause the computing device to perform functions is described. The functions may comprise generating a display of a random content on a head-mounted display (HMD) of a wearable computing system. The random content may at least include among other content a content personalized to a user of the wearable computing system including one or more of a name and a picture associated with the user. The wearable computing system may be operable to be in a locked mode of operation and may include an eye tracking system. The functions may also comprise receiving information associated with a gaze location of an eye of the user from the eye tracking system. The functions may further comprise determining that the gaze location substantially matches a given location of the content personalized to the user on the HMD. The functions may also comprise determining that a responsiveness metric is less than a predetermined threshold. The responsiveness metric may include a time period elapsed between generating the display of the random content on the HMD and determining that the gaze location substantially matches the given location of the content personalized to the user on the HMD. The functions may further comprise authenticating the user. Authenticating the user may comprise a switch from the wearable computing system being in the locked mode of operation to being in an unlocked mode of operation. Functionality of the wearable computing system may be reduced in the locked mode as compared to the unlocked mode.

In still another aspect, a system is described. The system may comprise a wearable computer including a head-mounted display (HMD). The wearable computer may be operable to be in a locked mode of operation. The system may also comprise an eye tracking system in communication with the wearable computer. The eye tracking system may be configured to track eye movement of a user of the wearable computer. The system may further comprise a processor in communication with the wearable computer and the eye tracking system. The processor may be configured to generate a display of a plurality of moving objects on a display of the HMD. The processor may also be configured to receive information associated with the eye movement from the eye tracking system. Based on the information associated with the eye movement, the processor may further be configured to determine that a path associated with the eye movement substantially matches a path of a given moving object of the plurality of moving objects. A characteristic associated with the given moving object may match a predetermined characteristic. The processor may further be configured to authenticate the user. Authenticating the user may comprise a switch from the wearable computing system being in the locked mode of operation to being in an unlocked mode of operation. Functionality of the wearable computing system may be reduced in the locked mode as compared to in the unlocked mode.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram of an example wearable computing and head-mounted display system, in accordance with an example embodiment.

FIG. 2A illustrates a front view of a head-mounted display (HMD) in an example eyeglasses embodiment.

FIG. 2B illustrates a side view of the HMD in the example eyeglasses embodiment.

FIG. 3 is a flow chart of an example method to authenticate a user using eye tracking information.

FIG. 4 is a diagram illustrating the example method to authenticate the user using eye tracking information depicted in FIG. 3.

FIG. 5 is a flow chart of another example method to authenticate a user using eye tracking information.

FIG. 6 is a diagram illustrating the example method to authenticate a user using eye tracking information depicted in FIG. 5.

FIG. 7 is a functional block diagram illustrating an example computing device used in a computing system that is arranged in accordance with at least some embodiments described herein.

FIG. 8 is a schematic illustrating a conceptual partial view of an example computer program product that includes a computer program for executing a computer process on a computing device, arranged according to at least some embodiments presented herein.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

This disclosure may disclose, inter alia, systems and methods for authenticating a user using eye tracking information. A wearable computing system may include a head mounted display (HMD). The wearable computing system may be operable to be in a locked mode of operation after a period of inactivity by a user. Locked mode of operation may include a locked screen and reduced functionality of the wearable computing system. The user may be authenticated to be able to use the wearable computing system after the period of inactivity. To authenticate the user, the wearable computing system may generate a display of a random content on the HMD. The random content may include a content personalized to the user. The wearable computing system may receive information associated with a gaze location of an eye of the user and determine that the gaze location substantially matches a predetermined location of the content personalized to the user on the HMD and authenticate the user.

The content personalized to the user may include names and pictures associated with the user such as names and pictures of the user or people or objects related to the user (e.g., wife, children, etc.). The user may be able to identify the content personalized to the user faster than another person who may not be as familiar as the user with the content personalized to the user. The wearable computing system may determine a responsiveness metric that includes a time period elapsed between generating the display of the random content and determining that the gaze location of the eye of the user substantially matches the predetermined location on the HMD of the content personalized to the user. The responsiveness metric may be determined to be less than a predetermined threshold indicating that the user identified the content personalized to the user within a predetermined time period. Identifying the content personalized to the user within the predetermined time period that may indicate familiarity with the content personalized to the user and the user may be authenticated.

In another example, to authenticate the user after a period of inactivity that may have caused the screen to be locked, a processor coupled to the wearable computing system may generate a display of a plurality of moving objects. Each of the plurality of moving objects may have a unique characteristic, such as shape or color. Paths of the plurality of moving objects may be randomly generated. The processor may detect through an eye tracking system coupled to the wearable computing system if an eye of a wearer of the HMD may be tracking a moving object with a predetermined characteristic. The processor may determine that a path associated with the movement of the eye of the wearer matches or substantially matches a path of the moving object and may authenticate the user. Tracking a slowly moving object may reduce a probability of eye blinks, or rapid eye pupil movements (i.e., saccades) disrupting the eye tracking system. The processor may generate the display of the plurality of moving objects such that speeds associated with motion of the moving objects on the HMD may be less than a predetermined threshold speed. Onset of rapid eye pupil movements may occur if a speed of a moving object tracked by the eye of the wearer is equal to or greater than the predetermined threshold speed. Alternatively, the speed associated with the moving object may be independent of correlation to eye blinks or rapid eye movements.

The speed associated with the motion of the moving object may change, i.e., the moving object may accelerate or decelerate. The processor may track the eye movement of the eye of the wearer to detect if the eye movement may indicate that the eye movement may be correlated with changes in the speed associated with the motion of the moving object and may authenticate the user accordingly.

Alternative to the processor generating the display of the plurality of moving objects on the HMD, the processor may cause an image or a sequence of images including the random content or the plurality of moving objects to be projected on a retina of the eye of the wearer and may determine if the eye pupil of the wearer may be tracking the moving object with the predetermined characteristic in the sequence of images, for example.

The eye tracking system may comprise a camera that may continuously be enabled to monitor eye movement. The wearable computing system may alternatively include a sensor, which may consume less electric power than the camera, to detect if a user may attempt to use the wearable computing system after a period of inactivity and then enable the camera to cause the eye tracking system to be operable. The user may additionally perform a gesture to indicate an attempt to use the wearable computing system. For example, a gyroscope coupled to the HMD may detect a head tilt, for example, which may indicate that the wearer may be attempting to use the HMD and the wearable computing system may authenticate the user.

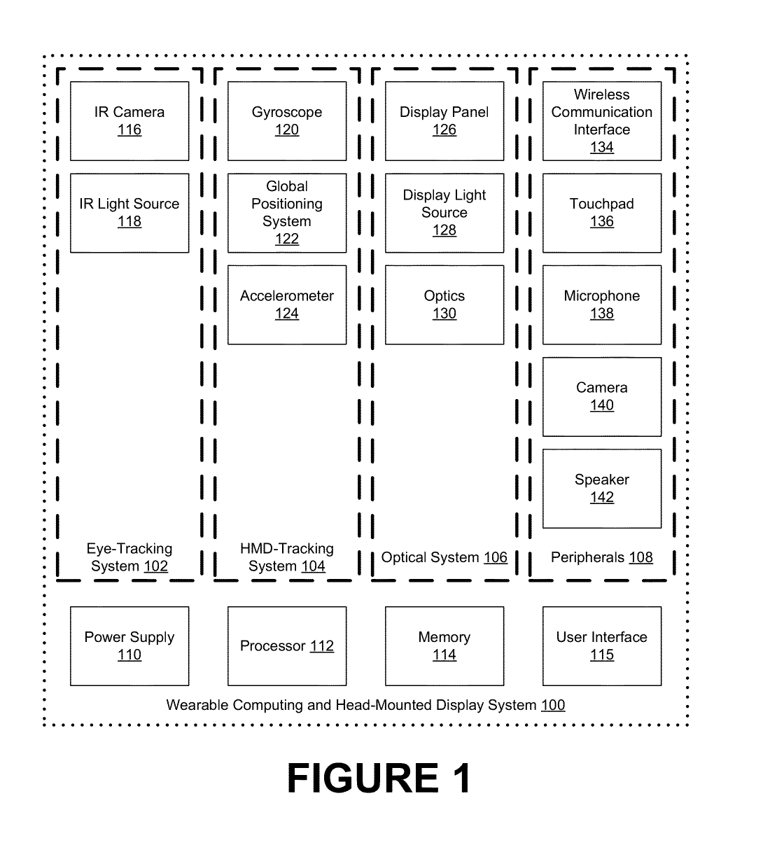

Referring now to the figures, FIG. 1 is a block diagram of an example wearable computing and head-mounted display (HMD) system 100 that may include several different components and subsystems. Components coupled to or included in the system 100 may include an eye-tracking system 102, a HMD-tracking system 104, an optical system 106, peripherals 108, a power supply 110, a processor 112, a memory 114, and a user interface 115. Components of the system 100 may be configured to work in an interconnected fashion with each other and/or with other components coupled to respective systems. For example, the power supply 110 may provide power to all the components of the system 100. The processor 112 may receive information from and may control the eye tracking system 102, the HMD-tracking system 104, the optical system 106, and peripherals 108. The processor 112 may be configured to execute program instructions stored in the memory 114 to generate a display of images on the user interface 115.

The eye-tracking system 102 may include hardware such as an infrared camera 116 and at least one infrared light source 118. The infrared camera 116 may be utilized by the eye-tracking system 102 to capture images of an eye of the wearer. The images may include either video images or still images or both. The images obtained by the infrared camera 116 regarding the eye of the wearer may help determine where the wearer may be looking within a field of view of the HMD included in the system 100, for instance, by ascertaining a location of the eye pupil of the wearer. The infrared camera 116 may include a visible light camera with sensing capabilities in the infrared wavelengths.

The infrared light source 118 may include one or more infrared light-emitting diodes or infrared laser diodes that may illuminate a viewing location, i.e. an eye of the wearer. Thus, one or both eyes of a wearer of the system 100 may be illuminated by the infrared light source 118. The infrared light source 118 may be positioned along an optical axis common to the infrared camera, and/or the infrared light source 118 may be positioned elsewhere. The infrared light source 118 may illuminate the viewing location continuously or may be turned on at discrete times.

The HMD-tracking system 104 may include a gyroscope 120, a global positioning system (GPS) 122, and an accelerometer 124. The HMD-tracking system 104 may be configured to provide information associated with a position and an orientation of the HMD to the processor 112. The gyroscope 120 may include a microelectromechanical system (MEMS) gyroscope or a fiber optic gyroscope as examples. The gyroscope 120 may be configured to provide orientation information to the processor 112. The GPS unit 122 may include a receiver that obtains clock and other signals from GPS satellites and may be configured to provide real-time location information to the processor 112. The HMD-tracking system 104 may further include an accelerometer 124 configured to provide motion input data to the processor 112.

The optical system 106 may include components configured to provide images to a viewing location, i.e. an eye of the wearer. The components may include a display panel 126, a display light source 128, and optics 130. These components may be optically and/or electrically-coupled to one another and may be configured to provide viewable images at the eye of the wearer. One or two optical systems 106 may be provided in the system 100. In other words, the HMD wearer may view images in one or both eyes, as provided by one or more optical systems 106. Also, the optical system(s) 106 may include an opaque display and/or a see-through display coupled to the display panel 126, which may allow a view of the real-world environment while providing superimposed virtual images. The infrared camera 116 coupled to the eye tracking system 102 may be integrated into the optical system 106.

Additionally, the system 100 may include or be coupled to peripherals 108, such as a wireless communication interface 134, a touchpad 136, a microphone 138, a camera 140, and a speaker 142. Wireless communication interface 134 may use 3G cellular communication, such as CDMA, EVDO, GSM/GPRS, or 4G cellular communication, such as WiMAX or LTE. Alternatively, wireless communication interface 134 may communicate with a wireless local area network (WLAN), for example, using WiFi. In some examples, wireless communication interface 134 may communicate directly with a device, for example, using an infrared link, Bluetooth, near field communication, or ZigBee.

The power supply 110 may provide power to various components in the system 100 and may include, for example, a rechargeable lithium-ion battery. Various other power supply materials and types known in the art are possible.

The processor 112 may execute instructions stored in a non-transitory computer readable medium, such as the memory 114, to control functions of the system 100. Thus, the processor 112 in combination with instructions stored in the memory 114 may function as a controller of system 100. For example, the processor 112 may control the wireless communication interface 134 and various other components of the system 100. In other examples, the processor 112 may include a plurality of computing devices that may serve to control individual components or subsystems of the system 100. Analysis of the images obtained by the infrared camera 116 may be performed by the processor 112 in conjunction with the memory 114.

In addition to instructions that may be executed by the processor 112, the memory 114 may store data that may include a set of calibrated wearer eye pupil positions and a collection of past eye pupil positions. Thus, the memory 114 may function as a database of information related to gaze direction and location. Calibrated wearer eye pupil positions may include, for instance, information regarding extents or range of an eye pupil movement (right/left and upwards/downwards), and relative position of eyes of the wearer with respect to the HMD. For example, a relative position of a center and corners of an HMD screen with respect to a gaze direction or a gaze angle of the eye pupil of the wearer may be stored. Also, locations or coordinates of starting and ending points, or waypoints, of a path of a moving object displayed on the HMD, or of a static path (e.g., semicircle, Z-shape etc.) may be stored on the memory 114.

The system 100 may further include the user interface 115 for providing information to the wearer or receiving input from the wearer. The user interface 115 may be associated with, for example, displayed images, a touchpad, a keypad, buttons, a microphone, and/or other peripheral input devices. The processor 112 may control functions of the system 100 based on input received through the user interface 115. For example, the processor 112 may utilize user input from the user interface 115 to control how the system 100 may display images within a field of view or may determine what images the system 100 may display.

Although FIG. 1 shows various components of the system 100 (i.e., wireless communication interface 134, processor 112, memory 114, infrared camera 116, display panel 126, GPS 122, and user interface 115) as being integrated into the system 100, one or more of the described functions or components of the system 100 may be divided up into additional functional or physical components, or combined into fewer functional or physical components. For example, the infrared camera 116 may be mounted on the wearer separate from the system 100. Thus, the system 100 may be part of a wearable computing device in the form of separate devices that can be worn on or carried by the wearer. Separate components that make up the wearable computing device may be communicatively coupled together in either a wired or wireless fashion. In some further examples, additional functional and/or physical components may be added to the examples illustrated by FIG. 1. In other examples, the system 100 may be included within other systems.

The system 100 may be configured as, for example, eyeglasses, goggles, a helmet, a hat, a visor, a headband, or in some other form that can be supported on or from a head of the wearer. The system 100 may be further configured to display images to both eyes of the wearer. Alternatively, the system 100 may display images to only one eye, either a left eye or a right eye.

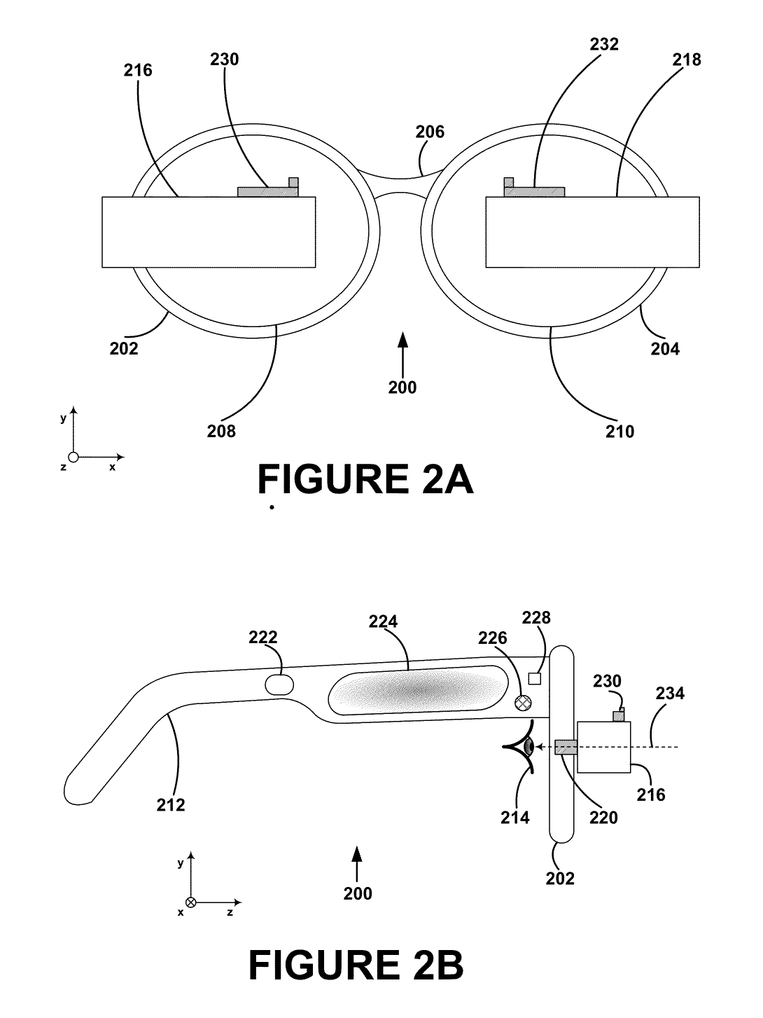

FIG. 2A illustrates a front view of a head-mounted display (HMD) 200 in an example eyeglasses embodiment. FIG. 2B presents a side view of the HMD 200 in FIG. 2A. FIGS. 2A and 2B will be described together. Although this example embodiment is provided in an eyeglasses format, it will be understood that wearable systems and HMDs may take other forms, such as hats, goggles, masks, headbands and helmets. The HMD 200 may include lens frames 202 and 204, a center frame support 206, lens elements 208 and 210, and an extending side-arm 212 that may be affixed to the lens frame 202. There may be another extending side arm affixed to the lens frame 204 but is not shown. The center frame support 206 and side-arm 212 may be configured to secure the HMD 200 to a head of a wearer via a nose and an ear of the wearer. Each of the frame elements 202, 204, and 206 and the extending side-arm 212 may be formed of a solid structure of plastic or metal, or may be formed of a hollow structure of similar material so as to allow wiring and component interconnects to be internally routed through the HMD 200. Lens elements 208 and 210 may be at least partially transparent so as to allow the wearer to look through lens elements. In particular, a right eye 214 of the wearer may look through right lens 210. Optical systems 216 and 218 may be positioned in front of lenses 208 and 210, respectively. The optical systems 216 and 218 may be attached to the HMD 200 using support mounts such as 220 shown for the right optical system 216. Furthermore, the optical systems 216 and 218 may be integrated partially or completely into lens elements 208 and 210, respectively.

Although FIG. 2A illustrates an optical system for each eye, the HMD 200 may include an optical system for only one eye (e.g., right eye 214). The wearer of the HMD 200 may simultaneously observe from optical systems 216 and 218 a real-world image with an overlaid displayed image. The HMD 200 may include various elements such as a processor 222, a touchpad 224, a microphone 226, and a button 228. The processor 222 may use data from, among other sources, various sensors and cameras to determine a displayed image that may be displayed to the wearer. The HMD 200 may also include eye tracking systems 230 and 232 that may be integrated into the optical systems 216 and 218, respectively. The locations of eye tracking systems 230 and 232 are for illustration only. The eye tracking systems 230 and 232 may be positioned in different locations and may be separate or attached to the HMD 200. A gaze axis or direction 234 associated with the eye 214 may be shifted or rotated with respect to the optical system 216 or eye tracking system 230 depending on placement of the HMD 200 on the nose and ears of the wearer. The eye-tracking systems 230 and 232 may include hardware such as an infrared camera and at least one infrared light source, but may include other components also. In one example, an infrared light source or sources integrated into the eye tracking system 230 may illuminate the eye 214 of the wearer, and a reflected infrared light may be collected with an infrared camera to track eye or eye-pupil movement. Those skilled in the art would understand that other user input devices, user output devices, wireless communication devices, sensors, and cameras may be reasonably included in such a wearable computing system.

The HMD 200 may enable the wearer to observe surroundings of the wearer and also view a displayed image on a display of the optical systems 216 and 218. In some cases, the displayed image may overlay a portion of a field of view of the wearer. Thus, while the wearer of the HMD 200 may be performing daily activities, such as walking, driving, exercising, etc., the wearer may be able to see a displayed image generated by the HMD 200 at the same time that the wearer may be looking out at the surroundings. The wearer may take off the HMD 200 or may stop using the HMD 200 for a period of time. After a period of inactivity by the wearer, the HMD 200 may lock a display screen coupled to the HMD 200 and reduce functionality of the HMD 200 to save power. The wearer may attempt to use the HMD 200 but may be authenticated by the HMD 200 before the wearer may be able to use the HMD 200 again.

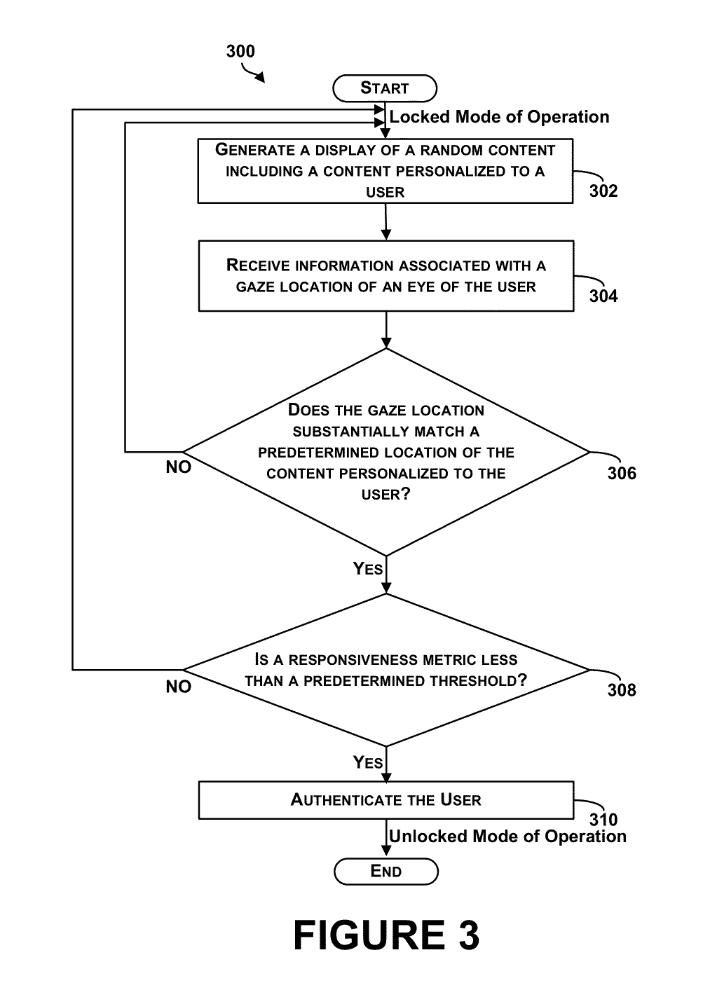

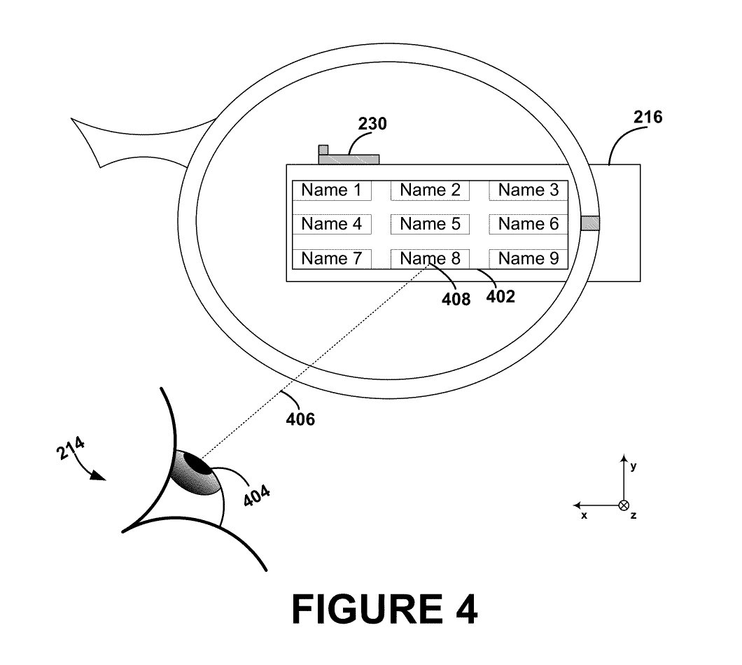

FIG. 3 is a flow chart illustrating an example method 300 to authenticate a user using eye tracking information. FIG. 4 is a diagram illustrating the example method 300 to authenticate a user using eye tracking information as depicted in FIG. 3, in accordance with at least some embodiments of the present disclosure. FIGS. 3 and 4 will be described together.

FIGS. 3 and 4 illustrate the method 300 in a context of a wearable computing system including a head-mounted display integrated into eyeglasses. However, the method applies to any computing system for authenticating a user and unlocking a screen coupled to the computing system using eye tracking information.

Method 300 may include one or more operations, functions, or actions as illustrated by one or more of blocks 302, 304, 306, 308, and 310. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation

In addition, for the method 300 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 300 and other processes and methods disclosed herein, each block in FIG. 3 may represent circuitry that is wired to perform the specific logical functions in the process.

A wearable computing system including a head-mounted display (HMD) may operate in a locked mode of operation after a period of inactivity by a wearer or a user. The locked mode of operation may include locking a display screen coupled to the HMD and a reduction in a functionality of the wearable computing system to save power. For the user to be able to use the HMD again, the wearable computing system may authenticate the user.

At block 302, method 300 includes generate a display of a random content including a content personalized to a user. To authenticate the user, a processor coupled to the wearable computing system may generate the display of the random content on the HMD. The random content may include the content personalized to the user. For example, the processor may generate a display of a grid including multiple random pictures. The grid may include multiple cells and a picture may be displayed in each cell, for example. One of the pictures in the grid may be associated with the user such as a picture of the user as a child, a picture of a wife, child, relative, or a friend of the user, a picture of a school where the user may have studied, a picture of an intersection close to where the user may have lived, or a picture of logos from institutions associated with the user (university logos, corporate logos, etc.). The processor may, for example, obtain the pictures associated with the user from a social networking account of the user. More than one picture in the grid may be associated with the user. In another example, the processor may display a grid of random names. A grid may include multiple cells and a name may be displayed in each cell, for example. One of the names in the grid may be associated with the user (e.g., a name of the user, a name of the wife, child, friend, or relative of the user). More than one picture in the grid may be associated with the user. The grid of random names or random pictures may include different pictures or names every time the wearable computing system may authenticate the user.

In other examples, the processor coupled to the wearable computing system may receive the generated display of random content from a server, and may provide the display on a screen of the HMD.

FIG. 4 illustrates the HMD integrated into eyeglasses. FIG. 4 shows the right side of the eyeglasses for illustration. However, the method 300 may apply to both left and right sides. The HMD integrated into the eyeglasses in FIG. 4 may, for example, be the HMD described in FIG. 2.

In FIG. 4, on a display screen or panel of the optical system 216, the processor of the wearable computing system may generate a display of a grid 402 of random names, for example. FIG. 4 shows the grid 402 including nine cells, each cell displaying a name. Other grid configurations may be possible. More or fewer cells may be displayed. A mix of names and pictures or any content may also be used. The grid 402 of random names may include names that may be unknown to the user and one or more names that may be known or personalized to the user (e.g., name of a wife, children, relative, friend, or acquaintance or of the user).

At block 304, method 300 includes receive information associated with a gaze location of an eye of the user. For example, in FIG. 4, the eye tracking system 230 may track eye movement of the eye 214 of the user. The eye tracking system 230 may, for example, track movements of an eye pupil 404 and a gaze axis 406 associated with the eye 214 and eye pupil 404. As the eye 214 or eye pupil 404 moves, the eye tracking system 230 may track a gaze location 408 on the HMD associated with the gaze axis 406. The processor coupled to the wearable computing system may receive the information associated with the gaze location 408 from the eye tracking system 230.

In one example, the eye tracking system 230 may be continuously enabled to monitor the eye 214 of the user. In another example, the eye tracking system 230 may be disabled until another sensor or input to the wearable computing system may indicate an attempt by the user to activate the HMD after a period of inactivity, for example. The wearable computing system may accordingly attempt to authenticate the user. For example, the user may perform a gesture such as head tilt or head shake. A gyroscope coupled to the wearable computing system may detect such gesture. The processor coupled to the wearable computing system may receive information associated with the gyroscope indicating the gesture and may interpret the gesture as an attempt by the user to activate and use the HMD. As another example, the user may press a button coupled to the wearable computing system to indicate an attempt to activate the HMD. Upon detecting the attempt, the processor may enable the eye tracking system 230. As yet another example, a low power reflectivity sensor system that detects if the eye pupil 404 may be pointing or gazing at the screen may be used to detect the attempt. The low power reflectivity sensor system may include an infrared (IR) light emitting diode (LED) and photo detector that may be directed at the eye pupil 404. When the eye pupil 404 may be gazing at the IR LED to attempt to unlock the screen, the amount of IR light reflected back to the photo detector may drop, for example. Using another sensor, gesture, a button, or the amount of IR light reflected back to the photo detector to indicate the attempt and consequently enabling the eye tracking system 230 may save power since the eye tracking system 230 may not be running continuously.

At decision block 306, method 300 determines whether the gaze location associated with the eye 214 of the user substantially matches a predetermined location of the content personalized to the user. Based on the information associated with the gaze location 408 of the eye 214, the processor may compare the gaze location 408 with the predetermined location of the content personalized to the user. For example, in FIG. 4, the gaze location 408 matches a location of a cell of the grid 402 displaying “Name 8”. If “Name 8” is associated with the user and includes the content personalized to the user, then the processor may determine that the gaze location 408 substantially matches the predetermined location of the content personalized to the user, “Name 8” in this case. FIG. 4 shows rectangular cells containing the random content and the content personalized to the user. The processor may determine that if the gaze location is in a rectangular area containing “Name 8”, i.e., the content personalized to the user, then the gaze location may substantially match the predetermined location of the content personalized to the user, for example. In another example, the processor may determine a circular area with a given radius contained in the cell containing the content personalized to the user. If the gaze location is in the circular area, then the gaze location may substantially match the predetermined location of the content personalize to the user. Other geometric shapes and areas may be used to determine an area such that if the gaze location is in the area, then the gaze location may substantially match the predetermined location of the content personalized to the user.

In some examples, the processor may adjust the gaze location associated with the eye 214 of the user before comparing the gaze location to the predetermined location of the content personalized to the user. For example, placement of eyeglasses including the wearable computing system and the HMD on ears and a nose of the user may be slightly different every time the user wears the eyeglasses after taking the eyeglasses off. A relative location of the eye with respect to a camera coupled to the eye tracking system 230 or a relative location of the gaze axis 406 associated with the eye 214 with respect to a reference axis associated with the HMD may vary. Therefore, the processor may apply a transform to the gaze location 408 to compensate for a difference in the relative location. The transform may, for example, include an offset of the gaze location 408 to compensate for a shift in the gaze axis 406 of the eye 214 of the user of the HMD with respect to the reference axis associated with the HMD. The transform may comprise a rotational adjustment to compensate for a rotation in the gaze axis 406 of the eye 214 of the user of the HMD with respect to the reference axis associated with the HMD. The transform may further comprise a scale factor that may compensate for a distance between a camera, coupled to the eye tracking system, monitoring the eye movement of the wearer, or a reference point on the HMD, and the eye of the wearer. As a position of the camera or the reference point changes (e.g., farther or closer to the eye of the wearer) the scale factor may compensate for the change in position of the camera or the reference point with respect to the eye of the wearer.

If the gaze location 408 does not substantially match the predetermined location of the content personalized to the user, the HMD may remain in a locked and an authentication of the user may fail.

At block 308, if the gaze location 408 matches or substantially matches the predetermined location of the content personalized to the user, possibly after an adjustment of the gaze location by the processor, the method 300 may determine whether a responsiveness metric is less than a predetermined threshold or not. The user may be able to identify and gaze at the content personalized to the user faster than another person who may not be familiar with the content personalized to the user. The user may, for example, recognize the name of the user in a grid of random names in a period of time less than a predetermined period of time or threshold and quicker than any other person. A responsiveness of the user may be quantified by a responsiveness metric. The responsiveness metric may include a time period elapsed between generating the display of the random content and determining that the gaze location 408 substantially matches the predetermined location of the content personalized to the user on the HMD. A person who may not be familiar with the content personalized to the user may not be able to identify and gaze at the content personalized to the user or may take a longer period of time to identify and gaze at the content personalized to the user than the user.

If the responsiveness metric is greater than the predetermined period of time or threshold, the HMD may remain in a locked and an authentication of the user may fail.

At block 310, if the responsiveness metric is less than the predetermined period of time or threshold, method 300 includes authenticate the user. The wearable computing system may switch to be in an unlocked mode of operation and may allow the user to use the HMD and the method 300 terminates.

In another example, the method 300 may include additional or alternative functions. For example, the processor may generate the content personalized to the user to be displayed in more than one location on the HMD. For example, the random content may be a grid of nine pictures; three of the nine pictures may be associated with the user. The user may gaze at the three pictures associated with the user in a given sequence. The processor may receive information associated with a sequence of gaze locations of the eye of the user. The processor may also receive information associated with temporal characteristics of eye movement of the user between gaze locations of the sequence of gaze locations. The temporal characteristics may include time periods elapsed between the gaze locations. The processor may determine that the sequence of gaze locations and temporal characteristics of the eye movement between the gaze locations substantially match a predetermined spatial-temporal sequence of locations associated with the content personalized to the user on the HMD, and authenticate the user.

In still another example, the processor may generate a display of random content on multiple sequential screens, and may prompt the user to gaze at a location of content personalized to the user in each screen. If a sequence of gaze locations (e.g., a gaze location per screen) matches predetermined locations of the content personalized to the user in the sequence of screen, the user may be authenticated.

In yet another example, steps of the method 300 may be performed in a different order. The processor may generate a display of random content of the HMD, may receive information associated with the gaze location of the eye of the user from the eye tracking system, and may associate a content displayed at a given location on the HMD with the gaze location. The processor may then determine if the content displayed at the given location includes content associated with the user or personalized to the user and may authenticate the user accordingly.

In still another example, the processor may generate a display of random words on the HMD. Table 1 shows an example of such display or random words. Table 1 shows five columns and five rows, but other arrangements are also possible. In Table 1, column 1 includes adjectives, column 2 includes plural nouns, column 3 includes verbs, column 4 includes adverbs, and column 5 includes adjectives are shown for illustration only. Other word types may be used. In some example, pictures, numbers, symbols, or icons may be used. The wearable computing system and the user may set a predetermined sentence for authenticating the user. For example: “Green tomatoes taste very good.” To authenticate the user, the processor may generate a display such as Table 1, and the user may trace the words that compose the sentence with the eyes of the user. The processor may receive information associated with gaze locations of the eye of the user and may determine whether the sequence of gaze locations substantially matches a predetermined spatial sequence of locations associated with words of the predetermined sentence. The wearable computing system may accordingly authenticate the user. The predetermined sentence may not be grammatically coherent. Any sequence of words, symbols, pictures, numbers, etc., can be set by the wearable computing system and the user. As a number of items included in a table such as Table 1 may increase, combinations of possible sentences may increase. For example, for Table 1, there are 5̂5 (i.e. 3,125) possible sentences. For a seven column five rows table, the number of combinations of possible sentences is 7̂5 (i.e. 16,807). A large number of combinations of sentences or sequences of items may preclude other users or automated systems from guessing or identifying the sentence set by the wearable computing system and the user for authentication.

TABLE 1

| | | | | |
|---|---|---|---|---|
| Green | Tomatoes | Look | Very | Good |
| Red | Aliens | Taste | Really | Bad |
| Orange | Shoes | Smell | Quite | Funny |
| Small | Flowers | Feel | A bit | Odd |
| Old | Dogs | Sound | Mildly | Sad |

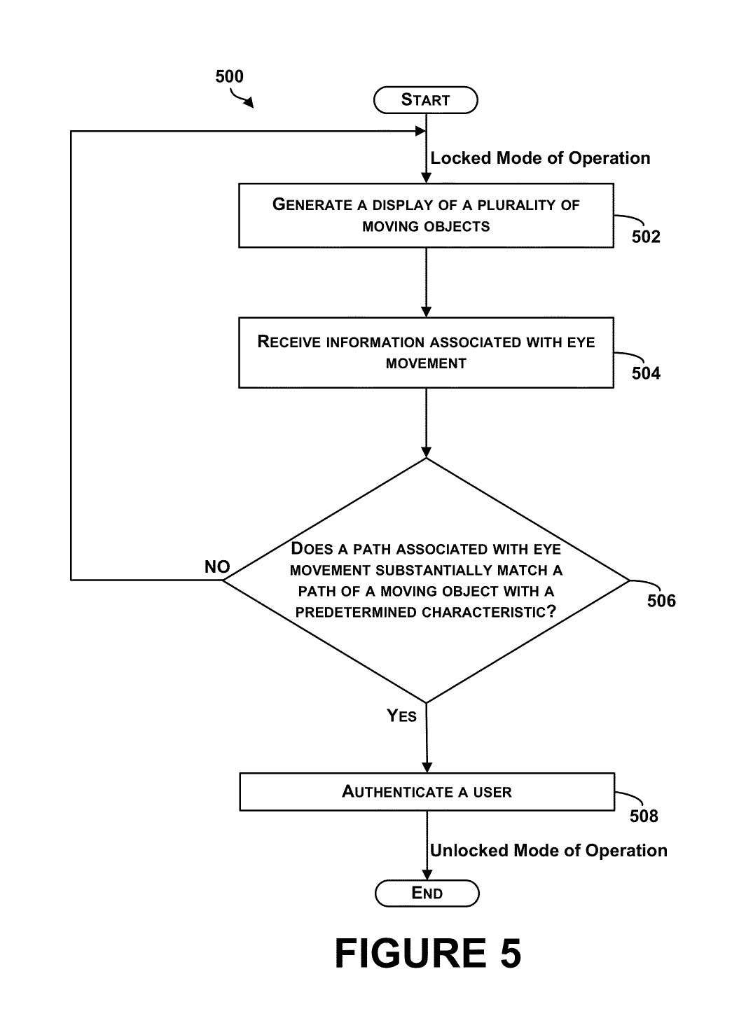

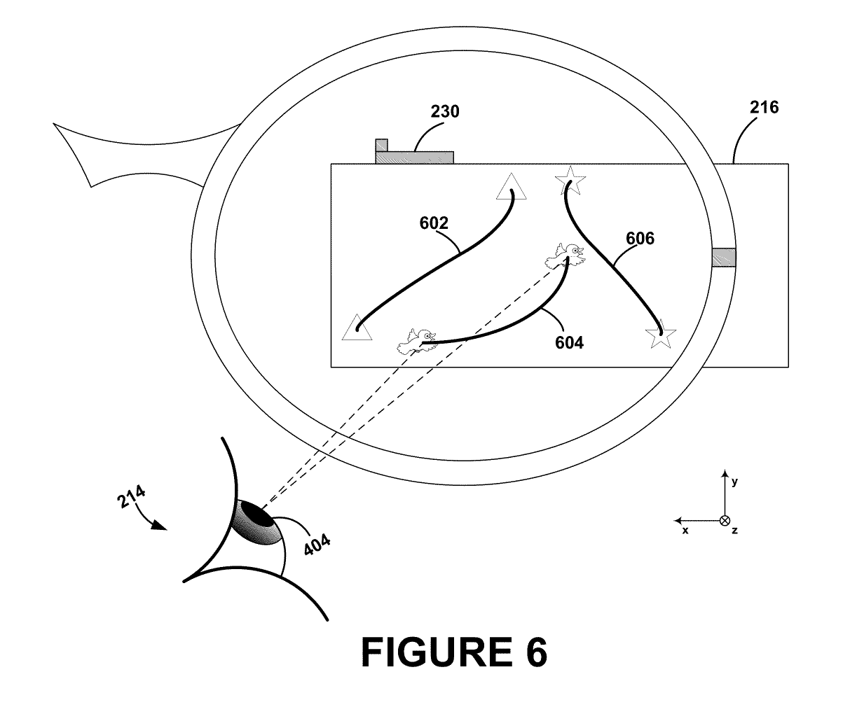

FIG. 5 is a flow chart illustrating another example method 500 to authenticate a user using eye tracking information. FIG. 6 is a diagram illustrating the example method 500 to authenticate a user using eye tracking information depicted in FIG. 5, in accordance with at least some embodiments of the present disclosure. FIGS. 5 and 6 will be described together.

Method 500 also starts with the wearable computing system including the HMD operating in a locked mode of operation after a period of inactivity by the user.

At block 502, method 500 includes generate a display of a plurality of moving objects. The user may attempt to activate the wearable computing system after the period of inactivity. A processor coupled to the wearable computing system may generate the display of the plurality of moving objects on the HMD. The display of the plurality of moving objects may be randomly generated by the processor. For example, a random display generated by the processor may comprise different object shapes or colors and a different path of motion for each object of the plurality of moving objects. The processor may render paths of the plurality of moving objects on the HMD.

FIG. 6 illustrates the HMD integrated into eyeglasses. FIG. 6 shows the right side of the eyeglasses for illustration. However, the method 500 may apply to both left and right sides. The HMD integrated into the eyeglasses in FIG. 6 may, for example, be the HMD described in FIG. 2.

In FIG. 6, on a display of the optical system 216, the processor of the wearable computing system may generate the display of the plurality of moving objects such as a triangle moving through a path 602, a bird moving through a path 604, and a star moving through a path 606, for example. Different shapes and colors may be used. These three shapes are used in describing method 500 as an illustration. A unique characteristic may be associated with each of the plurality of moving objects that may distinguish each moving object from other moving objects. For example, a moving object may have a different shape or a different color that distinguishes the moving object from other moving objects. In another example, rendered paths 602, 604, and 606 may have different distinguishing colors.

The processor may display the triangle, bird, and star moving at speeds that may match an ability of a human eye to follow moving objects without saccades. Saccades include rapid eye movement that may disturb the eye tracking system 230, or cause the eye tracking system 230 to determine a path of eye movement with less accuracy. In another example, the processor may display the plurality of moving objects at any speed and the eye tracking system 230 may not be disturbed.

In some examples, eyes may not look at a scene in fixed steadiness; instead, the eyes may move around to locate interesting parts of the scene and may build up a mental three-dimensional map corresponding to the scene. One reason for saccadic movement of an eye may be that a central part of the retina—known as the fovea—plays a role in resolving objects. By moving the eye so that small parts of the scene can be sensed with greater resolution, body resources can be used more efficiently. Eye saccades may be fast if the eye is attempting to follow an object that is moving with a speed that exceeds a certain predetermined speed. Once saccades start, fast eye movement may not be altered or stopped. Saccades may take 200 milliseconds (ms) to initiate, and then may last from 20-200 ms, depending on amplitude of the saccades (e.g., 20-30 ms is typical in language reading). Saccades may disturb or hinder an ability of the eye tracking system 230 to track eye movement. To prevent such disturbance to the eye tracking system 230, the processor may generate the display of the moving object such that the speed of the moving object may be below a predetermined threshold speed. If the speed exceeds the predetermined threshold speed, saccades may be stimulated. Consequently, the eye tracking system 230 may be disturbed and a performance of the eye tracking system 230 may deteriorate. In this case, the eye tracking system may not be able to accurately track eye movement or eye pupil movement of the user of the wearable computing system.

At block 504, method 500 includes receive information associated with eye movement. For example, in FIG. 4, the eye tracking system 230 may track eye movement of the eye 214 of the user. The eye tracking system 230 may, for example, track movements of the eye pupil 404. As the eye 214 or eye pupil 404 moves, the eye tracking system 230 may track a path associated with the eye 214 or the eye pupil 404 movement. The processor coupled to the wearable computing system may receive the information associated with the path associated with the eye movement from the eye tracking system 230.

At decision block 506, method 500 may determine whether a path associated with the eye movement substantially matches a path of a moving object with a predetermined characteristic. To authenticate the user of the HMD, the user or the wearable computing system may set a predetermined characteristic that may distinguish a moving object of the plurality of moving objects over other objects of the plurality of moving objects. The moving object may include a picture associated with the user, for example. The predetermined characteristic may include a shape or color associated with the moving object or a color of a rendered path of the moving object. For example, the predetermined characteristic may include a shape of a bird. Thus, for the user to be authenticated, an eye or both eyes of the user may track a path associated with a moving bird on the HMD and may ignore paths of other moving objects. Based on the information associated with the eye movement, the processor may, for example, compare the path associated with the eye movement to the path 604 associated with the moving object with the predetermined characteristic (i.e., the moving bird) generated by the processor as depicted in FIG. 6. The predetermined characteristic may also include a direction of motion associated with the moving object. For example, the processor may generate a display of four moving objects; each moving object moving in a different direction (e.g., North, East, South, and West). The predetermined characteristic may be set by the wearable computer system to be one of four directions, e.g., East. For the user to be authenticated, the user may track a moving object moving to the East and ignore other moving objects, for example. In yet another example, the predetermined characteristic may include a size of the moving object.

In some examples, the processor may adjust the path associated with the eye movement of the user before comparing the path associated with the eye movement to the path 604 of the moving bird. As described in method 300, the processor may apply a transform to the path associated with the eye movement to compensate for a difference in a relative location of a gaze axis associated with an eye of the user with respect to a reference axis associated with the HMD. The transform may, for example, include an offset of the path associated with the eye movement to compensate for a shift in the gaze axis of the eye of the user with respect to the reference axis associated with the HMD. The transform may comprise a rotational adjustment to compensate for a rotation in the gaze axis of the eye of the user of the HMD with respect to the reference axis associated with the HMD. The transform may further comprise a scale factor that may compensate for a distance between a camera, coupled to the eye tracking system, monitoring the eye movement of the wearer, or a reference point on the HMD, and the eye of the wearer. As a position of the camera or the reference point changes (e.g., farther or closer to the eye of the wearer) the scale factor may compensate for the change in position of the camera or the reference point with respect to the eye of the wearer.

At block 508, method 500 includes authenticate the user. If the path associated with the eye movement or eye pupil movement of the user matches or substantially matches the path 604 of the moving object with the predetermined characteristic, possibly after adjusting the path associated with the eye movement, the wearable computing system may authenticate the user and switch to be in an unlocked mode of operation. The unlocked mode of operation may comprise unlocking the display screen of the HMD and may comprise increasing a functionality of the wearable computing system.

If the path associated with the eye movement or eye pupil movement of the user does not match or does not substantially match the path 604 of the moving object with the predetermined characteristic, the wearable computing system may remain in the locked mode of operation.

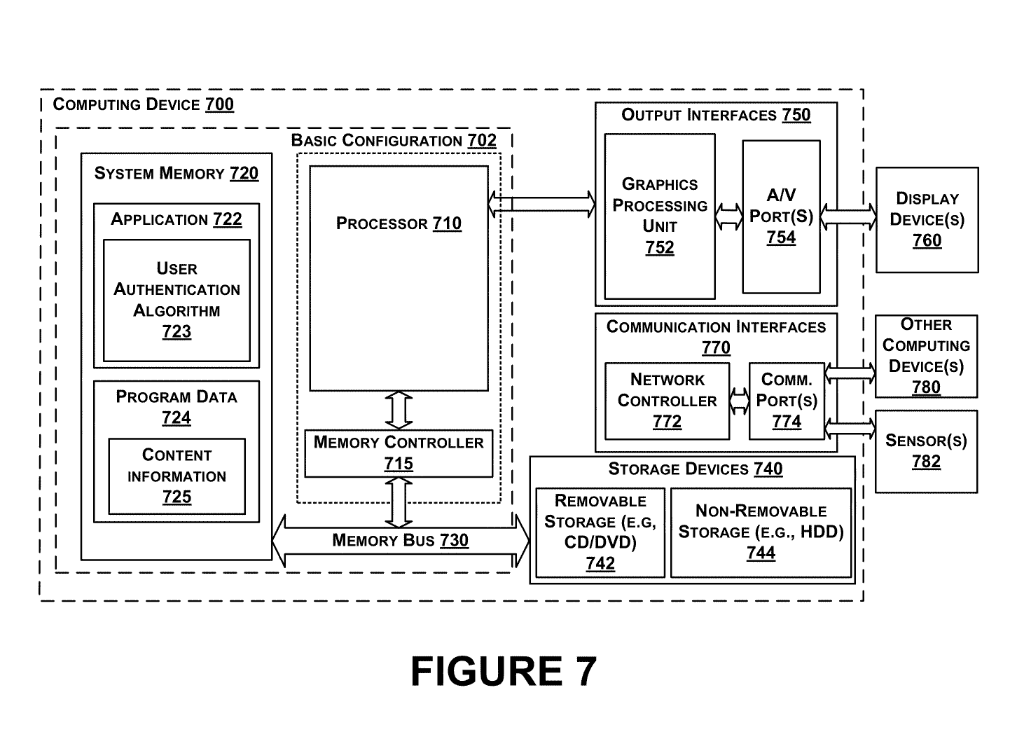

FIG. 7 is a functional block diagram illustrating an example computing device 700 used in a computing system that is arranged in accordance with at least some embodiments described herein. The computing device may be a personal computer, mobile device, cellular phone, video game system, or global positioning system, and may be implemented as a client device, a server, a system, a combination thereof, or as a portion of components described in FIGS. 1, 2, and 4. In a basic configuration 702, computing device 700 may include one or more processors 710 and system memory 720. A memory bus 730 can be used for communicating between the processor 710 and the system memory 720. Depending on the desired configuration, processor 710 can be of any type including but not limited to a microprocessor (μP), a microcontroller (μC), a digital signal processor (DSP), or any combination thereof. A memory controller 715 can also be used with the processor 710, or in some implementations, the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 may include one or more applications 722, and program data 724. Application 722 may include user authentication algorithm 723 that is arranged to provide inputs to the electronic circuits, in accordance with the present disclosure. Program Data 724 may include content information 725 that could be directed to any number of types of data. In some example embodiments, application 722 can be arranged to operate with program data 724 on an operating system.

Computing device 700 can have additional features or functionality, and additional interfaces to facilitate communications between the basic configuration 702 and any devices and interfaces. For example, data storage devices 740 can be provided including removable storage devices 742, non-removable storage devices 744, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer readable instructions, data structures, program modules, or other data.

System memory 720 and storage devices 740 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include output interfaces 750 that may include a graphics processing unit 752, which can be configured to communicate to various external devices such as display devices 760 or speakers via one or more A/V ports 754 or a communication interface 770. The communication interface 770 may include a network controller 772, which can be arranged to facilitate communications with one or more other computing devices 780 and one or more sensors 782 over a network communication via one or more communication ports 774. The one or more sensors 782 are shown external to the computing device 500, but may also be internal to the device. The communication connection is one example of a communication media. Communication media may be embodied by computer readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

Computing device 700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

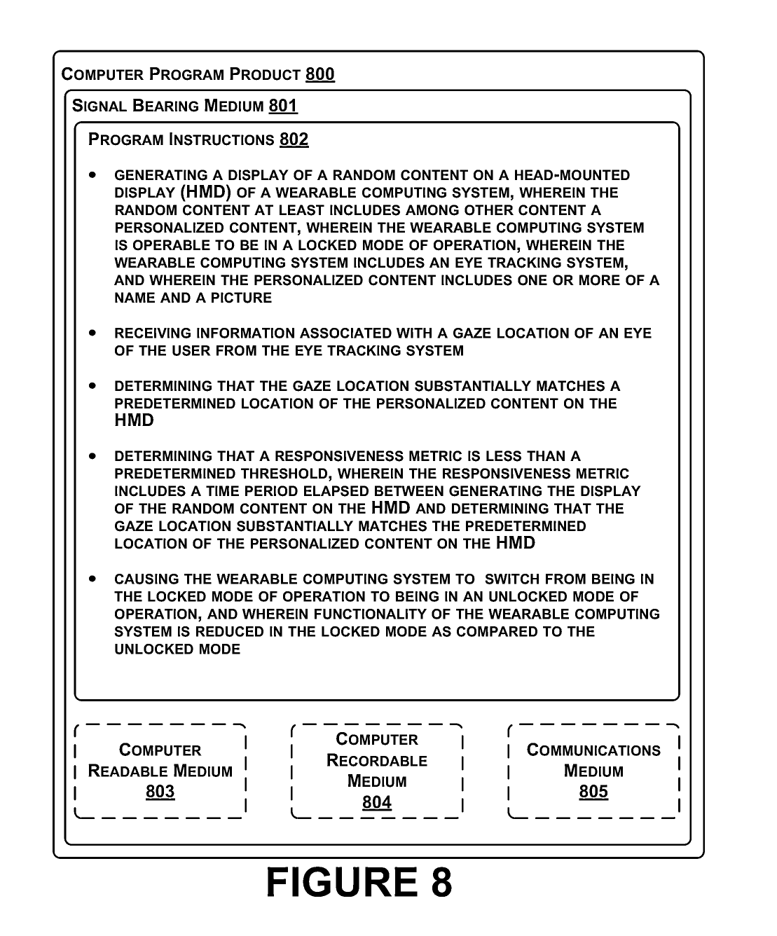

In some embodiments, the disclosed methods may be implemented as computer program instructions encoded on a computer-readable storage media in a machine-readable format, or on other non-transitory media or articles of manufacture. FIG. 8 is a schematic illustrating a conceptual partial view of an example computer program product 800 that includes a computer program for executing a computer process on a computing device, arranged according to at least some embodiments presented herein. In one embodiment, the example computer program product 800 is provided using a signal bearing medium 801. The signal bearing medium 801 may include one or more program instructions 802 that, when executed by one or more processors may provide functionality or portions of the functionality described above with respect to FIGS. 1-7. Thus, for example, referring to the embodiments shown in FIGS. 3 and 5, one or more features of blocks 302-310 and/or blocks 502-508 may be undertaken by one or more instructions associated with the signal bearing medium 801. In addition, the program instructions 802 in FIG. 8 describe example instructions as well.

In some examples, the signal bearing medium 801 may encompass a computer-readable medium 803, such as, but not limited to, a hard disk drive, a Compact Disc (CD), a Digital Video Disk (DVD), a digital tape, memory, etc. In some implementations, the signal bearing medium 801 may encompass a computer recordable medium 804, such as, but not limited to, memory, read/write (R/W) CDs, R/W DVDs, etc. In some implementations, the signal bearing medium 801 may encompass a communications medium 805, such as, but not limited to, a digital and/or an analog communication medium (e.g., a fiber optic cable, a waveguide, a wired communications link, a wireless communication link, etc.). Thus, for example, the signal bearing medium 801 may be conveyed by a wireless form of the communications medium 805 (e.g., a wireless communications medium conforming to the IEEE 802.11 standard or other transmission protocol).

The one or more programming instructions 802 may be, for example, computer executable and/or logic implemented instructions. In some examples, a computing device such as the computing device 700 of FIG. 7 may be configured to provide various operations, functions, or actions in response to the programming instructions 802 conveyed to the computing device 700 by one or more of the computer readable medium 803, the computer recordable medium 804, and/or the communications medium 805. It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method comprising:
receiving information indicating a request to switch a wearable computing system from being in a locked mode of operation to being in an unlocked mode of operation, wherein the wearable computing system includes a head-mounted display (HMD) and an eye-sensing system, wherein the eye-sensing system is in a disabled state, and wherein the information indicating the request is received via a sensor coupled to the HMD;
in response to receiving the information indicating the request, causing the eye-sensing system to switch from the disabled stated to an enabled state;
generating a display of a random content on the HMD, wherein the random content at least includes among other content a personalized content, and wherein the personalized content includes one or more of a name and a picture;
receiving information associated with a view location of an eye from the eye-sensing system;
determining that the view location substantially matches a predetermined location of the personalized content on the HMD;
determining that a responsiveness metric is less than a predetermined threshold, wherein the responsiveness metric includes a time period elapsed between generating the display of the random content on the HMD and determining that the view location substantially matches the predetermined location of the personalized content on the HMD; and
causing the wearable computing system to switch from being in the locked mode of operation to being in the unlocked mode of operation, wherein functionality of the wearable computing system is reduced in the locked mode as compared to the unlocked mode.

2. The method of claim 1, wherein determining that the view location substantially matches the predetermined location of the personalized content on the HMD comprises:
receiving information associated with a sequence of view locations of the eye from the eye-sensing system;
receiving information associated with a temporal characteristic of eye movement between view locations of the sequence of view locations, wherein the temporal characteristic includes a time period elapsed between the view locations;
determining that the sequence of view locations and the temporal characteristic of the eye movement between the view locations substantially match a predetermined spatial-temporal sequence of locations associated with the personalized content on the HMD.

3. The method of claim 2, wherein the sequence of view locations and the temporal characteristic of the eye movement between the view locations are associated with reading a predetermined sequence of words.

4. (canceled)

5. The method of claim 1, wherein the eye-sensing system comprises at least one sensor configured to trace eye movement.

6. The method of claim 1, further comprising adjusting the information associated with the view location of the eye based on a location of a view axis of the eye with respect to a reference axis associated with the HMD.

7. The method of claim 6, wherein adjusting the information associated with the view location of the eye comprises applying a transform to the view location, and wherein the transform comprises an offset associated with a shift in the view axis of the eye with respect to the reference axis associated with the HMD.

8. The method of claim 6, wherein adjusting the information associated with the view location of the eye comprises applying a transform to the view location, and wherein the transform comprises a rotational adjustment associated with a rotation in the view axis of the eye with respect to the reference axis associated with the HMD.

9. The method of claim 1, wherein the random content is arranged in a grid on the HMD comprising more than one cell, and wherein the personalized content is provided in at least one cell of the grid.

10. A non-transitory computer readable memory having stored thereon instructions executable by a wearable computing device to cause the wearable computing device to perform functions comprising:
receiving information indicating a request to switch the wearable computing device from being in a locked mode of operation to being in an unlocked mode of operation, wherein the wearable computing device includes a head-mounted display (HMD) and an eye-sensing system, wherein the eye-sensing system is in a disabled state, and wherein the information indicating the request is received via a sensor coupled to the HMD;
in response to receiving the information indicating the request, causing the eye-sensing system to switch from the disabled stated to an enabled state;
generating a display of a random content on the HMD, wherein the random content at least includes among other content a personalized content, and wherein the personalized content includes one or more of a name and a picture;
receiving information associated with a view location of an eye from the eye-sensing system;
determining that the view location substantially matches a given location of the personalized content on the HMD;
determining that a responsiveness metric is less than a predetermined threshold, wherein the responsiveness metric includes a time period elapsed between generating the display of the random content on the HMD and determining that the view location substantially matches the given location of the personalized content on the HMD; and
causing the wearable computing device to switch from being in the locked mode of operation to being in the unlocked mode of operation, wherein functionality of the wearable computing device is reduced in the locked mode as compared to in the unlocked mode.

11. (canceled)

12. The non-transitory computer readable memory of claim 10, wherein receiving the information indicating the request to switch the wearable computing device from being in the locked mode of operation to being in the unlocked mode of operation comprises receiving information associated with a gesture including a head motion.

13. The non-transitory computer readable memory of claim 10, wherein the instructions are further executable by the computing device to cause the computing device to perform functions comprising applying a transform to the information associated with the view location of the eye based on a location of a view axis of the eye with respect to a reference axis associated with the HMD, and wherein the transform includes one or more of: (i) an offset associated with a shift in the view axis of the eye with respect to the reference axis associated with the HMD, (ii) a rotational adjustment associated with a rotation in the view axis of the eye with respect to the reference axis associated with the HMD, and (iii) a scale factor associated with a distance between the eye and a reference point on the HMD.

14. A system comprising:
a wearable computer including a head-mounted display (HMD), wherein the wearable computer is operable to be in a locked mode of operation;
an eye-sensing system coupled to the wearable computer, wherein the eye-sensing system is in a disabled state; and
a processor coupled to the wearable computer and the eye-sensing system, wherein the processor is configured to:
receive information indicating a request to switch the wearable computer from being in the locked mode of operation to being in an unlocked mode of operation, wherein the information indicating the request is received via a sensor coupled to the HMD;
in response to receiving the information indicating the request, cause the eye-sensing system to switch from the disabled stated to an enabled state;
generate a display of a plurality of moving objects on a display of the HMD;
receive information associated with eye movement from the eye-sensing system;
based on the information associated with the eye movement, determine that a path associated with the eye movement substantially matches a path of a given moving object of the plurality of moving objects, wherein a characteristic associated with the given moving object matches a predetermined characteristic;
cause the wearable computer to switch from being in the locked mode of operation to being in the unlocked mode of operation, wherein functionality of the wearable computer is reduced in the locked mode as compared to in the unlocked mode.

15. (canceled)

16. (canceled)

17. The system of claim 14, wherein the predetermined characteristic distinguishes the given moving object from other moving objects of the plurality of moving objects.

18. The system of claim 14, wherein the predetermined characteristic includes at least one of: (i) a shape of the given moving object, (ii) a color of the given moving object, (iii) a color of a rendered path of the given moving object, (iv) a direction of motion of the given moving object, and (v) a size of the given moving object.

19. The system of claim 14, wherein the given moving object includes a picture.

20. The system of claim 14, wherein the processor is further configured to apply a transform to the information associated with the eye movement based on a location of a view axis of the eye with respect to a reference axis associated with the HMD, and wherein the transform includes one or more of: (i) an offset associated with a shift in the view axis of the eye with respect to the reference axis associated with the HMD, (ii) a rotational adjustment associated with a rotation in the view axis of the eye with respect to the reference axis associated with the HMD, and (iii) a scale factor associated with a distance between the eye and a reference point on the HMD.

21. The system of claim 14, wherein the eye movement comprises eye-pupil movement, and wherein the processor is further configured to:
randomly generate respective paths of the plurality of moving objects;
cause the HMD to render a display of the plurality of moving objects according to the paths; and
determine that a path associated with the eye-pupil movement substantially matches the path of the given moving object of the plurality of moving objects.

22. The system of claim 14, wherein the processor is configured to generate the display of the plurality of moving objects on the HMD such that speeds associated with motion of the plurality of moving objects on the HMD are less than a predetermined threshold speed, and wherein an onset of rapid eye movement disturbing the eye-sensing system occurs at a speed greater than the predetermined threshold speed.
